(19) United States
(12) Patent Application Publication
(10) Pub. No.: US 2025/0146506 A1
(43) Pub. Date: May 8, 2025

(54) FAN WITH ADJUSTABLE BLADE STRUCTURES

(71) Applicant: Microsoft Technology Licensing, LLC, Redmond, WA (US)

(72) Inventors: Chien Lung YANG, Sammamish, WA (US); Todd Alan CHILES, Redmond, WA (US); Bo DAN, Redmond, WA (US)

(73) Assignee: Microsoft Technology Licensing, LLC, Redmond, WA (US)

(21) Appl. No.: 18/691,009

(22) PCT Filed: Sep. 16, 2022
(86) PCT No.: PCT/US2022/076541

§ 371 Date: Mar. 11, 2024

(30) Foreign Application Priority Data
Sep. 30, 2021 (NL) 2029293

(51) Int. Cl. F04D 29/28; F04D 29/66

(52) U.S. Cl. CPC F04D 29/281; F04D 29/287; F04D 29/662

(57) ABSTRACT

Examples are disclosed that relate to fans configured to automatically adjust for imbalances in mass. One example provides a self-balancing fan, comprising a hub comprising a plurality of blade interfaces, and a plurality of blade structures each attached to a corresponding blade interface of the hub, each blade interface comprising a tapered notch in the hub and being configured to increase a balancing force exerted by the hub against the blade structure as a function of increasing distance of the blade structure from the hub.

### BACKGROUND

Fans are used in a wide variety of applications. For example, fans are often used to help cool heat-producing components in computing devices, such as personal computers, laptops, and gaming systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to fans configured to automatically adjust for imbalances in mass. One example provides a self-balancing fan, comprising a hub comprising a plurality of blade interfaces, and a plurality of blade structures each attached to a corresponding blade interface of the hub, each blade interface comprising a tapered notch in the hub and being configured to increase a balancing force exerted by the hub against the blade structure as a function of increasing distance of the blade structure from the hub.

### BRIEF DESCRIPTION OF THE DRAWINGS

FIG. 1 schematically illustrates an example of a balanced fan.

FIG. 2 schematically illustrates an example of an imbalanced fan.

FIG. 3 shows an exploded view of an example fan configured to automatically adjust for mass imbalances between blade structures.

FIG. 4 shows an unexploded, perspective view of the example fan of FIG. 3.

FIG. 5 shows a front view of the example fan of FIG. 3.

FIG. 6 shows an example fan hub and an example fan blade structure comprising a plurality of blades.

FIG. 7 shows an exploded view of an example fan having a plurality of the blade structures shown in FIG. 6.

FIGS. 8A and 8B schematically illustrate example movement of blade structures during operation of an example fan.

FIGS. 9A and 9B schematically illustrate example movement of blade structures during operation of another example fan.

FIG. 10 shows an example method of operating a fan.

FIG. 11 shows a block diagram of an example computing device incorporating a fan.

### DETAILED DESCRIPTION

As mentioned above, fans are often used to cool heat-producing components in computing devices, such as personal computers, laptops, and gaming systems. A properly balanced fan may provide for suitably quiet and vibration-free operation. Likewise, an imbalanced fan may cause vibrations that can impact fan performance and lifetime, and thus negatively impact product quality and user experience.

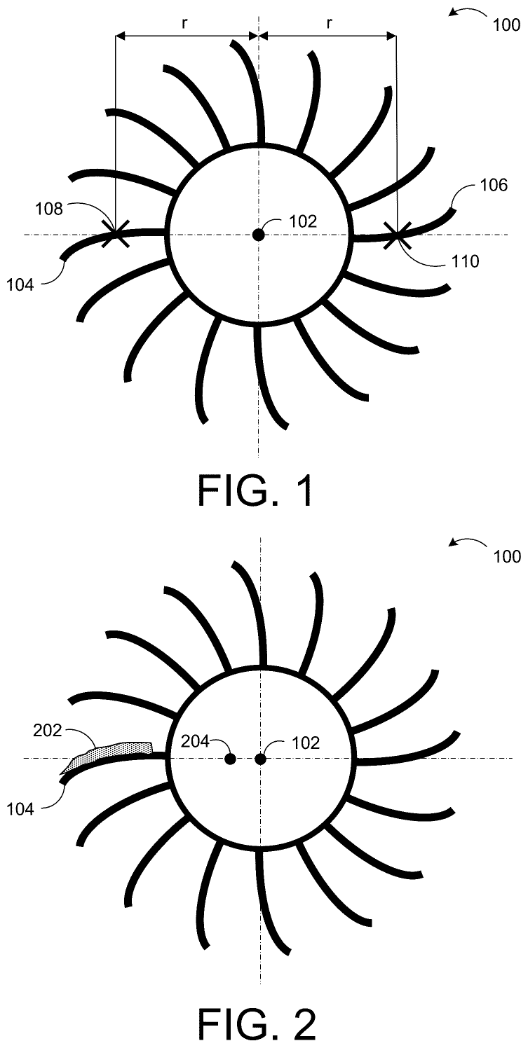

Manufacturing fans having proper balance poses various challenges. For example, the hub and blades of a fan impeller (the term “fan” is used herein to describe an impeller as well as an overall mechanical fan structure comprising the impeller) may have a unibody construction. A mold used to form such a unibody fan may be designed such that each blade has a substantially similar form (e.g. mass and dimensions) as all other blades to balance the centrifugal forces exerted by the blades when the fan spins. Referring to FIG. 1, which shows a schematic depiction of a balanced fan 100, in the rotating reference frame of the fan, the magnitude of the inertial centrifugal force F on an object of mass m at a distance r from the origin point with a rotating angular velocity ω is F=mω²r. Here, distance r is defined as the distance between a blade's mass center to fan center 102. Blade 104 has a mass center at 108, and blade 106 has a mass center at 110. When the distance r between the mass centers to the fan center 102 is sufficiently similar, the fan is balanced, in that a center of mass of the fan is sufficiently close to the fan center 102 to avoid noticeable and/or detrimental vibration during use.

However, consistently molding unibody fans can be difficult. For example, a material used to mold the fan may be inhomogeneous during injection, and/or dimension tolerances may cause slight blade shape differences. These factors can lead to imbalance and resulting vibration in some units. Further, even a fan that is properly balanced at manufacturing can become unbalanced during use. For example, blades may be damaged throughout the lifetime of a fan, and/or different masses of dust and debris may adhere to the blades. FIG. 2 schematically illustrates an imbalance of fan 100 caused by debris 202 adhered to blade 104. As illustrated, the center of mass of the fan is shifted due to the added mass of the debris 202 to location 204, spaced from the fan center 102. As a result, the fan may experience noticeable and/or detrimental vibration during operation.

To mitigate manufacturing variances that can impact fan performance, fan manufacturers may correct imbalances during manufacturing by adjusting the mass of one or more fan blades on a fan (e.g. by adhering clay to one or more blades and/or at a perimeter of the hub) to bring the fan into balance. However, such tuning of individual units increases manufacturing costs, and may be impractical or unavailable during the lifetime and use of a fan. Further, manufacturers of products that incorporate fans may mitigate noise and vibration problems by reducing fan speed or enhancing other mechanical designs. However, such remediations may sacrifice thermal performance and/or increase cost of production.

Accordingly, examples are disclosed herein that relate to fans configured to self-balance during use. In the disclosed examples, during manufacturing, fan blades are produced separately from the hub and then attached to the hub at interfaces configured to self-adjust during fan operation. More particularly, the hub has blade interfaces for receiving blade structures, while each blade structure has a hub interface for attaching to the hub. Each blade interface is configured to permit centrifugally driven outward motion of the blade structure relative to the hub in such a manner that a first, lighter blade structure moves outwardly a first distance during rotation, while a second, heavier blade structure moves outward a second distance that is less than the first distance. A distance of travel is limited to a balancing force applied by one of the hub or the blade structure against the other (e.g. a spring force), wherein the balancing force increases as a function of increasing distance of the blade structure outwardly from the hub. The term “self-balancing” herein refers to any adjustment in fan blade position relative to the hub that changes an overall balance of the fan from less balanced toward more balanced responsive to mass imbalances between blade structures.

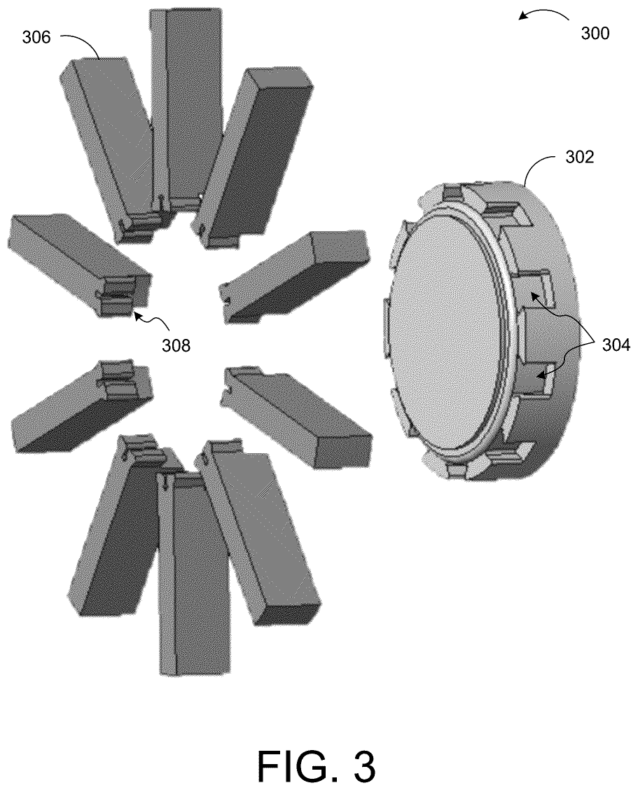

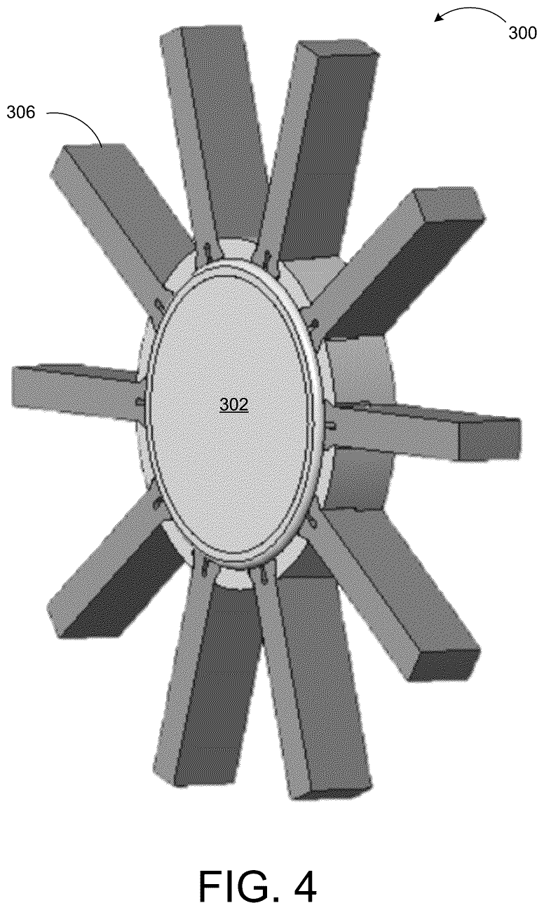

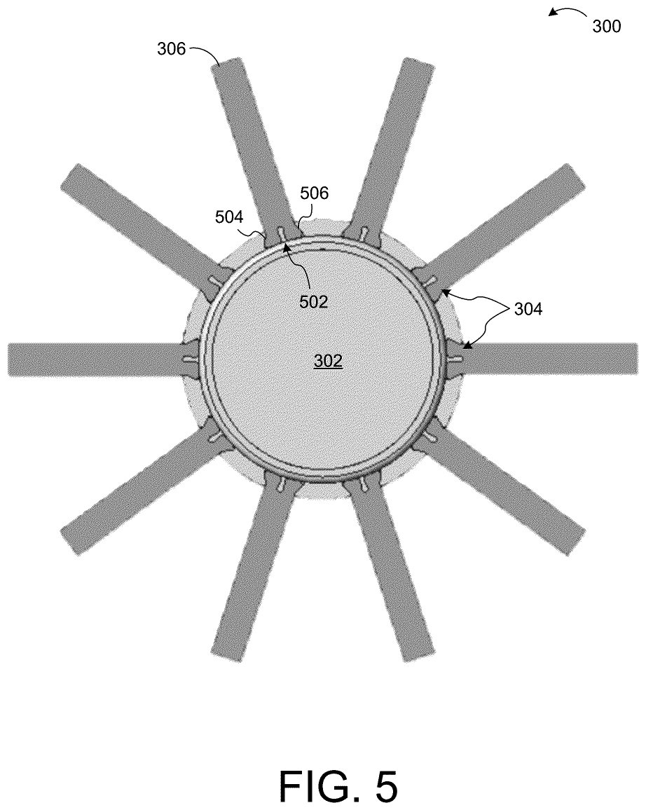

FIG. 3 shows an exploded view of an example fan 300 having a hub 302 with blade interfaces 304, and blade structures 306 each with a hub interface 308. FIG. 4 shows a perspective view of fan 300, and FIG. 5 shows a front view of fan 300, with the blade structures 306 attached to the hub 302. In this example, each blade interface 304 comprises a tapered notch in the hub 302 with a narrower width at a location farther from the center of the hub relative to a width at a location closer to the center of the hub. The hub interface 308 on each blade structure 306 comprises a flared end that fits within the blade interface 304, thereby attaching the blade structure 306 to the hub. The hub interfaces 308 and blade interfaces 304 are configured to permit the blade structures 306 to move outwardly relative to the hub 302 due to centrifugal forces acting on each blade structure 306 as the fan spins to thereby help bring the fan into balance. The shapes of the tapered notch and flared end may allow the blade structures 306 to move outwardly due to centrifugal force, yet prevent the blade structures from detaching from the hub.

The hub interface 308 further comprises a groove 502 separating a first side 504 of the hub interface and a second side 506 of the hub interface. The groove 502 allows first side 504 and second side 506 to be pushed inwardly from the tapered shape of the blade interface 304, thereby causing the first side 504 and the second side 506 to increase a spring force exerted against the sides of the blade interface 304 as the blade structure 306 moves outwardly relative to the hub 302. This further helps to provide for outwardly motion of the blade structures relative to the hub while preventing the blade structures from detaching from the hub.

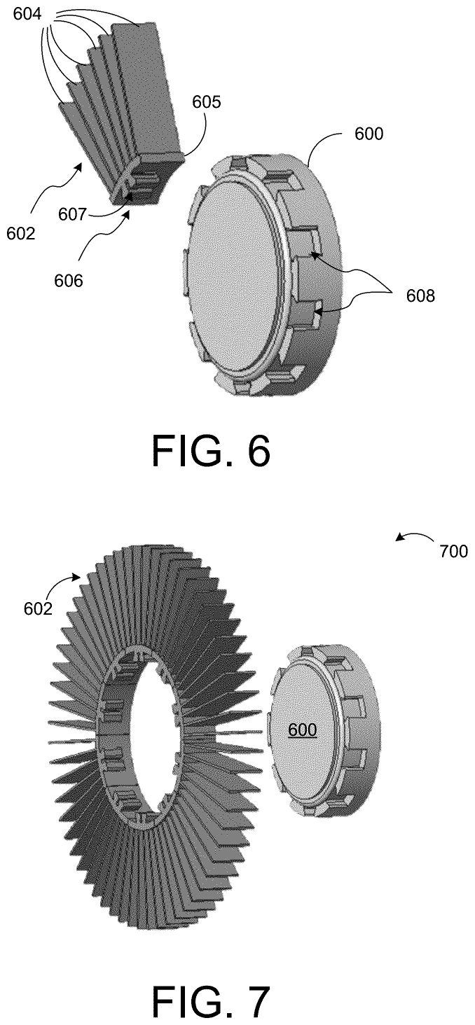

In the example of FIGS. 3-5, each blade structure comprises a single blade. In other examples, a blade structure may comprise a plurality of blades. FIG. 6 shows an example fan hub 600 and blade structure 602, wherein the blade structure 602 comprises a plurality of blades 604 grouped together. The plurality of blades 604 are attached to a base 605 of the blade structure 602. Blade structure 602 includes a hub interface 606 having a groove 607 that attaches to a corresponding blade interface 608 comprising a notch on the hub 600. FIG. 7 shows an exploded view of an example fan 700 having a plurality of blade structures 602. Such a fan may be faster to assemble compared to a fan having a single blade on each blade structure.

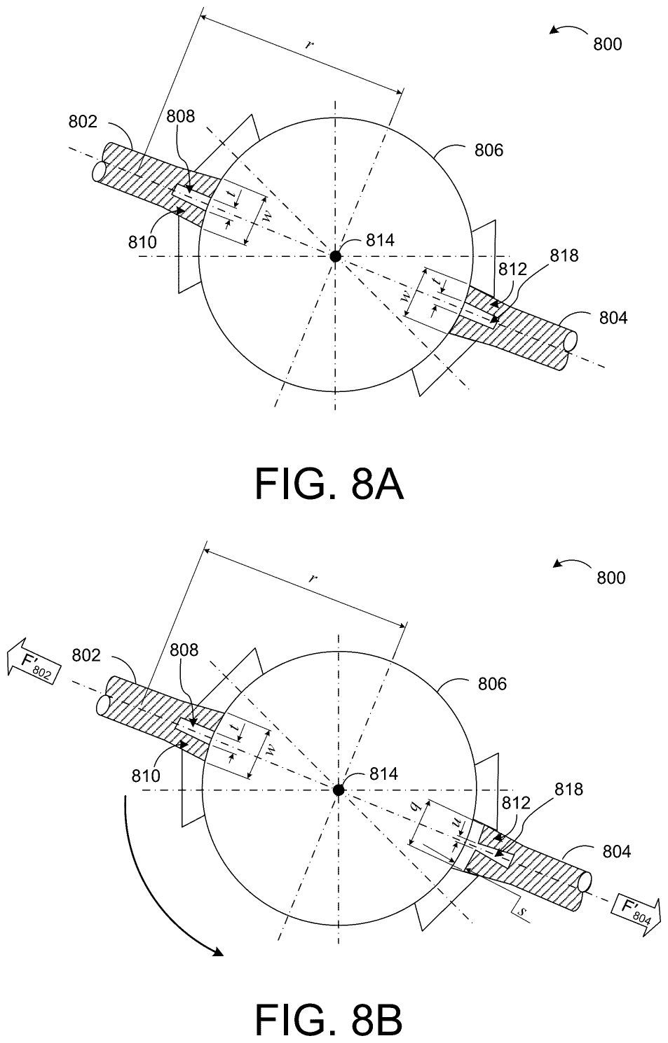

As mentioned above, the example fan configurations disclosed herein may allow for self-balancing while a fan is spinning, due to outward motion of each blade structure relative to the hub driven by factors such as centrifugal force and air pressure, balanced by friction and spring force. Each blade structure may move relative to the hub to a different extent depending on their differing masses, in such a manner as to automatically balance the fan. FIGS. 8A and 8B schematically illustrate movement of example blade structures of an example fan 800 when spinning. Blade structures 802 and 804 that are located on opposite sides of a hub 806 (other blade structures are omitted for clarity). FIG. 8A may represent fan 800 when the fan is at rest, or just at the start of spinning. In this example, it is assumed that blade structure 802 is more massive than blade structure 804, e.g. due to accumulated dust, manufacturing differences, damage, or other cause. The centrifugal force on blade structure 802 during rotation (F₈₀₂=mω²r) is higher than the centrifugal force on blade structure 804 due to its heavier mass m′, expressed as F′₈₀₂=m′ω²r.

The distance a blade structure moves outwardly from the hub may depend upon factors such as the mass of the blade structure (and corresponding inertia), friction between the blade structure and hub, the angular velocity, and the force exerted by air pressure on the moving blade structure. In FIG. 8A, neither blade structure has moved outwardly from the hub. In this figure, widths t of grooves 808, 818 are approximately the same, wherein “approximately the same” refers to a similarity within manufacturing tolerances. Likewise, side-to-side widths w of the hub interfaces 810, 812 are approximately the same. Referring next to FIG. 8B, as the fan spins, centrifugal forces and air pressure forces act upon both the blade structures 802 and 804. Blade structure 802, which is more massive, may move outwardly a smaller distance compared to lighter blade structure 804 under the influence of air pressure and inertia. Lighter blade structure 804 may move outwardly more than heavier blade structure 802 based on Newton's third law. On a whole fan system level, blades located oppositely may experience forces that are equal in magnitude and opposite in direction. When one blade structure becomes heavier, the oppositely located lighter blade structure may extend farther to acquire an approximately equivalent centrifugal force as the heavier blade structure, due to the imbalance in the fan. A reactive force applied by the lighter blade structure 804 on the opposite side of heavier blade structure 802, per Newton's third law from the whole fan system level, may shift the center of mass of the fan back to the center of the spinning axis, restoring balance. As lighter blade structure 804 moves outwardly, groove 818 may be narrowed by deflection of the first and second sides of the hub interface on lighter blade structure 804, increasing a exerting spring force against the blade interface until an equilibrium is reached. FIG. 8B depicts the groove width t on the blade structure 804 being narrowed to groove width u, and width w of the flared end also being narrowed to width q.

Due to the blade structure 804 having moved outwardly, the centrifugal force of blade structure 804 F₈₀₄=mω²r increases as a result of the longer distance from the fan center 814, expressed as F′₈₀₄=mω²(r+s). The resulting centrifugal forces F′₈₀₂ and F′₈₀₄ are approximately equivalent (the equilibrium also includes contributions from other forces, such as friction and air pressure). Thus, even though the mass of blade structure 802 is higher, the fan may be balanced due to the outward movement the blade structure 804 from the fan center 814 by a distance s, compensating for the extra weight of blade structure 802. The fan 800 thus may balance automatically, avoiding noise and vibration problems. In other examples, both blade structures 802 and 804 may move outwardly, but by different amounts.

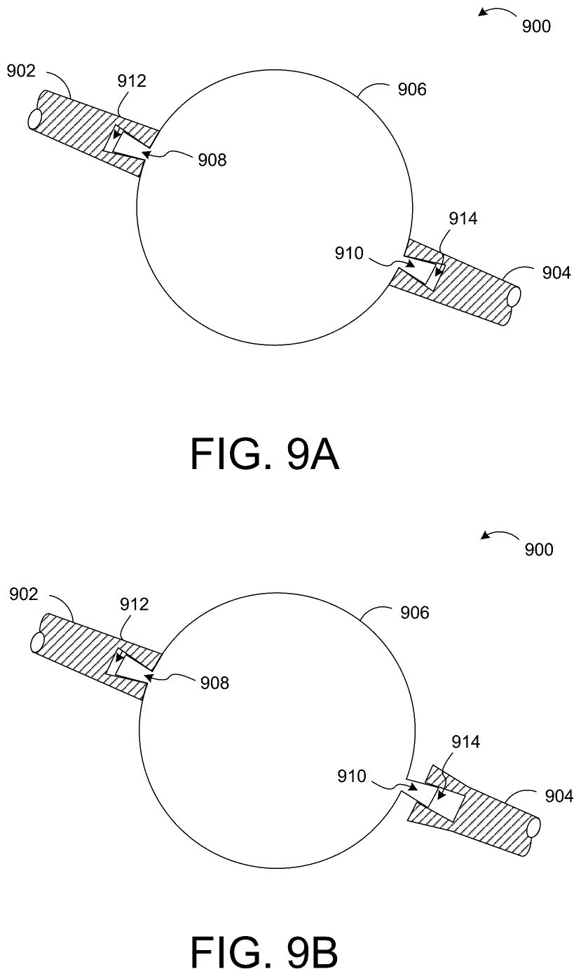

FIGS. 9A and 9B schematically show another example of hub and blade interfaces. Here, the blade interfaces of the hub 906 each includes a protrusion 908, 910 that is configured to fit within the groove 912, 914 of the hub interfaces of the blade structures 902 and 904. Thus, the sides of each hub interface are pushed outwardly, exerting an increasing spring force against the protrusions 908, 910 as each blade structure 902, 904 moves outwardly.

More particularly, FIG. 9A shows the fan 900 at rest or just starting to spin, while FIG. 9B shows the fan 900 while spinning. Fan 900 includes blade structures 902 and 904 that are located symmetrically and attached to hub 906, where blade structure 902 is assumed to be heavier than blade structure 904. In a similar fashion as described above with regard to FIG. 8B, when the fan is spinning, heavier blade 902 may move outward a smaller distance (or not at all) compared to lighter blade structure 904, which moves outward a greater distance. As described above, the relative distances moved by each blade structure may depend upon such factors as relative masses (and corresponding inertial effects), air pressure, centrifugal force, and friction. Outward motion of the blade structure 904 causes protrusion 910 to apply an increased spring force onto the hub interface of blade structure 904, until an equilibrium is reached, thereby keeping the blade structure 904 in place. Again, here the spring force exerted by the blade interface on the hub interface increases as a function of distance of the blade structure from the hub. As blade structure 904 moves outward a further distance from the hub than the blade structure 902, the increased centrifugal force exerted by blade structure 904 helps to balance out the increased centrifugal force on blade structure 902 resulting from the heavier mass of blade structure 902.

The configurations described above may be used in both centrifugal fans and axial fans. The disclosed concepts may apply to any suitable fans, from small fans installed in computing devices to large fans such as wind turbines.

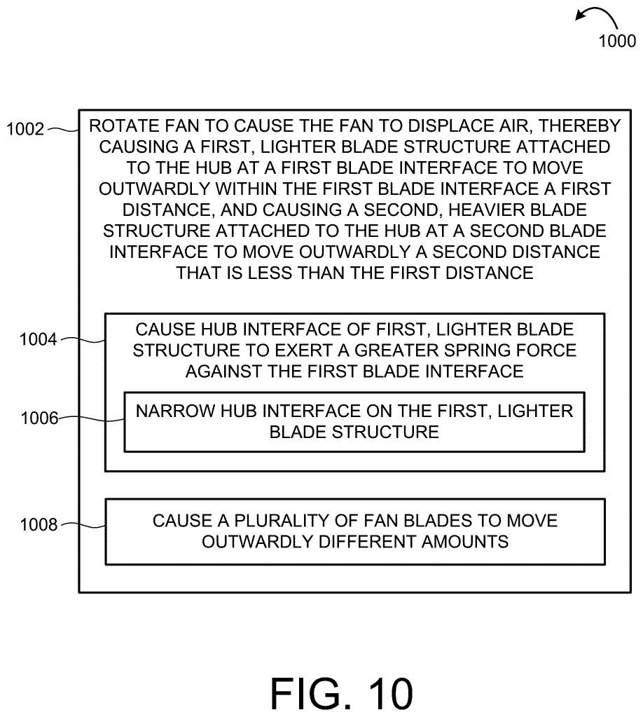

FIG. 10 shows a method 1000 of operating a fan according to the examples disclosed herein. Method 1000 includes, at 1002, rotating the hub to cause rotating the hub to cause the fan to displace air, thereby causing a first, lighter blade structure attached to the hub at a first blade interface to move outwardly within the first blade interface a first distance, and causing a second, heavier blade structure attached to the hub at a second blade interface to move outwardly a second distance that is less than the first distance. This may include causing a hub interface of the first, lighter blade structure to exert a greater spring force against the first blade interface, at 1004, which may include narrowing a hub interface on the first, lighter blade structure, at 1006. Causing the first, lighter blade structure to move outwardly a first distance may comprise causing a plurality of fan blades to move outward different amounts, at 1008.

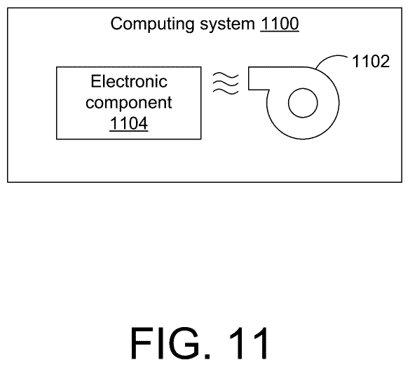

As mentioned above, a fan according to the present disclosure may be used in a variety of different contexts. FIG. 11 shows a block diagram of an example computing system 1100 incorporating a fan 1102 according to the present disclosure that is used to cool an electronic component 1104. Computing system 1100 may take any suitable form, including but not limited to a desktop computer, a laptop computer, a gaming system, one or more server computers (e.g. a rack of server computers configured for data center use), a tablet computer, or a wearable computer (e.g. a head-mounted display), as examples.

Another example provides a self-balancing fan, comprising a hub comprising a plurality of blade interfaces, and a plurality of blade structures each attached to a corresponding blade interface of the hub, each blade interface comprising a tapered notch in the hub and being configured to increase a balancing force exerted by the hub against the blade structure as a function of increasing distance of the blade structure from the hub. Each blade structure may additionally or alternatively include a hub interface, the hub interface comprising a groove separating a first side of the hub interface and a second side of the hub interface. Each hub interface may additionally or alternatively include a flared end. The tapered notch of each blade interface may additionally or alternatively include a narrower width at a location farther from a center of the hub relative to a width at a location closer to a center of the hub. Each blade structure may additionally or alternatively include a plurality of blades. The fan may additionally or alternatively include a centrifugal fan. Each blade interface may additionally or alternatively be configured to permit outward motion of the corresponding blade structure relative to the hub. In some such examples, the self-balancing fan may be incorporated in a computing device. The computing device may additionally or alternatively include one or more of a personal computer, a laptop, a gaming system, or a head-mounted display device.

Another example provides a method of operating a self-balancing fan comprising a plurality of blade structures attached to a hub via blade interfaces in the form of tapered notches in the hub, the method comprising rotating the hub to cause the fan to displace air, thereby causing a first, lighter blade structure attached to the hub at a first blade interface to move outwardly within the first blade interface a first distance, and causing a second, heavier blade structure attached to the hub at a second blade interface to move outwardly a second distance that is less than the first distance. Causing the first, lighter blade structure attached to the hub at the first blade interface to move outwardly may additionally or alternatively cause the first, lighter blade structure to exert a balancing force against the first blade interface. Causing the first, lighter blade structure attached to the hub at the first blade interface to move outwardly may additionally or alternatively cause the first, lighter blade structure to exert the balancing force against the first blade interface by narrowing a hub interface on the first, lighter blade structure. Causing the first, lighter blade structure to move outwardly a first distance may additionally or alternatively causing a first, lighter blade structure comprising a plurality of fan blades to move outwardly. Operating the fan may additionally or alternatively include operating a computing device that incorporates the fan.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A self-balancing fan, comprising:
a hub comprising a plurality of blade interfaces, each blade interface comprising a tapered notch in the hub; and
a plurality of blade structures, each blade structure comprising a hub interface, wherein each hub interface is received in a corresponding blade interface of the hub to attach the blade structure to the hub, wherein each blade interface and corresponding hub interface are configured to permit centrifugally driven outward motion of the corresponding blade structure relative to the hub, wherein a spring force exerted between the blade interface and the hub interface increases as a function of increasing distance of the blade structure from the hub to prevent the blade structure detaching from the hub.

2. The self-balancing fan of claim 1, wherein each hub interface further comprises a groove separating a first side of the hub interface and a second side of the hub interface.

3. The self-balancing fan of claim 1, wherein each hub interface comprises a flared end.

4. The self-balancing fan according to claim 1, wherein the tapered notch of each blade interface has a narrower width at a location farther from a center of the hub relative to a width at a location closer to a center of the hub.

5. The self-balancing fan according to claim 1, wherein each blade structure comprises a plurality of blades.

6. The self-balancing fan according to claim 1, wherein the fan is a centrifugal fan.

7. A computing device, comprising:
a self-balancing fan, comprising:
a hub comprising a plurality of blade interfaces, each blade interface comprising a protrusion; and
a plurality of blade structures, each blade structure comprising a hub interface, each hub interface comprising a tapered groove, wherein each blade interface is received in a corresponding hub interface to attach the blade structure to the hub, wherein each blade interface and hub interface are configured to permit centrifugally driven outward motion of the corresponding blade structure relative to the hub, wherein a spring force exerted between the blade interface and the hub interface increases as a function of increasing distance of the blade structure from the hub to prevent the blade structure detaching from the hub.

8. The computing device according to claim 7, wherein each protrusion is a flared protrusion.

9. The computing device of claim 7, wherein each blade structure comprises a plurality of blades.

10. The computing device according to claim 9, wherein the computing device comprises one or more of a personal computer, a laptop, a gaming system, or a head-mounted display device.

11. A method of operating a self-balancing fan comprising a plurality of blade structures attached to a hub via a plurality of hub interfaces and a plurality of blade interfaces, each blade structure comprising a hub interface received in a corresponding blade interface comprising a tapered notch in the hub, the method comprising:
rotating the hub to cause the fan to displace air, thereby causing a first, lighter blade structure attached to the hub at a first blade interface by a first hub interface to move outwardly within the first blade interface a first distance, and causing a second, heavier blade structure attached to the hub at a second blade interface by a second hub interface to move outwardly a second distance that is less than the first distance.

12. The method of claim 11, wherein causing the first, lighter blade structure attached to the hub at the first blade interface to move outwardly causes the first, lighter blade structure to exert a balancing force against the first blade interface.

13. The method of claim 12, wherein causing the first, lighter blade structure attached to the hub at the first blade interface to move outwardly causes the first, lighter blade structure to exert the balancing force against the first blade interface by narrowing a hub interface on the first, lighter blade structure.

14. The method of claim 11, wherein causing the first, lighter blade structure to move outwardly a first distance comprises causing a first, lighter blade structure comprising a plurality of fan blades to move outwardly.

15. The method of claim 11, wherein operating the fan comprises operating a computing device that incorporates the fan.

16. The computing device of claim 7, wherein the tapered groove of each blade interface has a narrower width at a location farther from a center of the hub relative to a width at a location closer to a center of the hub.

17. The computing device of claim 7, wherein one or more blade structures of the plurality of blade structures comprise a single blade.

18. The computing device of claim 7, wherein the fan is a centrifugal fan.

19. The method of claim 15, wherein the computing device comprises one or more of a personal computer, a laptop, a gaming system, or a head-mounted display device.

20. The method of claim 11, wherein causing the first, lighter blade structure to move outwardly the first distance comprises causing a first, lighter blade structure comprising a single fan blade to move outwardly.
